(19) United States
(12) Patent Application Publication
(10) Pub. No.: US 2009/0160151 A1
(43) Pub. Date: Jun. 25, 2009

(54) A-ARM FRAME WITH BEARING FOR HAULING DEVICES

(75) Inventor: Brian Gaumer, Watertown, CT (US)

Correspondence Address: MICHAUD-DUFFY GROUP LLP, 306 INDUSTRIAL PARK ROAD, SUITE 206, MIDDLETOWN, CT, 06457, US

(73) Assignee: ROLLER BEARING COMPANY OF AMERICA, INC., Oxford, CT (US)

(21) Appl. No.: 12/100,681

(22) Filed: Apr. 10, 2008

Related U.S. Application Data
(60) Provisional application No. 61/014,915, filed on Dec. 19, 2007.

(51) Int. Cl. B60G 9/00; F16C 33/10

(52) U.S. Cl. 280/124.1; 384/286

(57) ABSTRACT

An A-arm frame 10 for a vehicle has two arms 12, 14 that converge at an apex 16. Each arm has a mounting end opposite the apex for mounting to the housing for an axle of the vehicle. A pivot joint at the apex connects the A-arm frame to the vehicle frame. The pivot joint includes a case-hardened spherical plain bearing 22 that includes an inner ring 26 and an outer ring 28. The inner ring 26 may have a lubrication aperture therethrough, but the outer ring 28 has no lubrication aperture therethrough. The outer ring 28 may have a multi-fracture configuration and, therefore, a greater wrap-around of the inner ring 26 than it otherwise would have.

### CROSS-REFERENCE TO RELATED APPLICATION

This application claims the benefit of U.S. provisional application No. 61/014,915 filed Dec. 19, 2007, which is incorporated herein by reference.

### FIELD OF THE INVENTION

This invention relates to bearings in vehicles and in particular to spherical plain bearings for A-arm frames.

### BACKGROUND

Vehicles used for hauling large loads, such as those used in mining operations, are often equipped with rigid A-arm frames that connect their rear drive axles to the vehicle frames. The A-arm frame consists of two arms that are fixedly mounted onto the rear drive axle of the haul vehicle. The A-arm frame arms extend from the drive axle housing and converge together at an apex where a pivot joint is located. This pivot joint connects the A-arm and the axle housing to the vehicle frame. The pivot joint contains a spherical plain bearing that allows upward, downward, and side-to-side relative rotation between the support frame of the haul vehicle, the A-arm frame and the axle housing.

### SUMMARY OF THE INVENTION

The present invention resides in one aspect in an A-arm frame for joining an axle housing to a vehicle frame, the A-arm frame including two arms that converge at an apex. Each of the arms has a mounting end opposite from the apex, for mounting the A-arm frame to the housing of an axle of the vehicle. There is a pivot joint at the apex for connecting the A-arm frame to the vehicle frame. The pivot joint includes a case-hardened spherical plain bearing that has an inner ring and an outer ring.

The invention relates in another aspect to a vehicle comprising a vehicle frame, an axle having an axle housing and an A-arm frame as described herein. The A-arm frame is connected to the vehicle frame at the pivot joint via a linking pin in the spherical plain bearing. The A-arm frame is also connected to the axle housing at the mounting ends of the arms.

### BRIEF DESCRIPTION OF THE DRAWINGS

FIG. 1 is a schematic plan view of an A-arm frame containing a bearing according to one embodiment of the present invention;

FIG. 2 is an enlarged schematic cross-sectional view of a portion of the A-arm frame of FIG. 1;

FIG. 3 is a partial schematic cross-sectional view of a prior art bearing used in the A-arm frame of FIG. 1;

FIGS. 4A and 4B are schematic cross-sectional views of the bearing shown in FIG. 2; and

FIG. 5 is a perspective view of the A-arm frame of FIG. 2 mounted to an axle housing of a haul vehicle and connected to a vehicle frame.

### DETAILED DESCRIPTION OF THE INVENTION

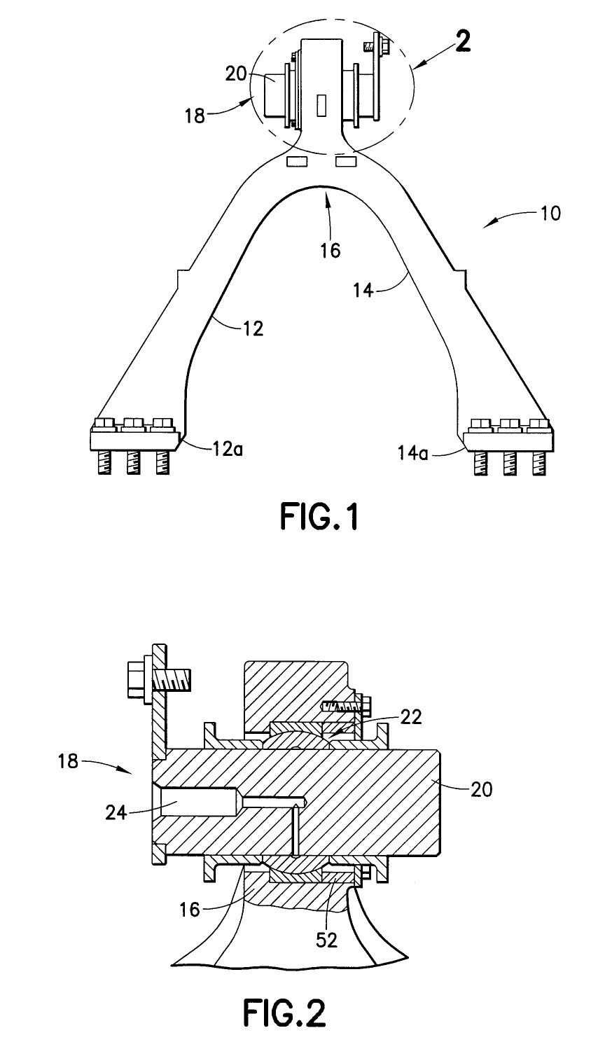

As shown in FIG. 1 an A-arm frame generally designated by the reference numeral 10 for use on a haul vehicle (not shown) has two arms 12, 14. Each of the arms has a mounting end 12a, 14a for mounting the A-arm frame 10 to the housing 40 (FIG. 5) for the rear drive axle of the vehicle. The arms 12, 14 converge at an apex 16 where a pivot joint 18 is mounted to connect the A-arm frame to the vehicle frame 50 (FIG. 5). A linking pin 20 provides a connection point for the vehicle frame, and the pin is rotatable and can slide axially (side-to-side) in the pivot joint 18.

As shown in FIG. 2, the linking pin 20 is mounted in a bearing 22 according to one specific embodiment of the present invention which is described more fully below. The linking pin 20 is equipped with a lubrication supply conduit 24 through which lubricant is provided to the interior of the bearing 22. To assemble the pivot joint 18 into the A-arm frame 10, the bearing 22 is pressed into a bearing seat (unnumbered) in the apex 16 and is secured therein by a retainer 52. The linking pin 20 is then pressed through the bearing 22.

A conventional bearing 122 that has previously been used in A-arm frame 10 in the place of the bearing 22 has, as seen in FIG. 3, an inner ring 126 and an outer ring 128 both made from high strength, through-hardened AISI E52100 (100Cr6) steel. The outer ring 128 has a lubrication aperture 129 therethrough and an exterior circumferential lubrication groove 131. The outer ring 128 is a single-fracture ring, and the axial ends 133, 135 of the concave bearing surface are contoured (i.e., rounded) to facilitate the assembly of the bearing 122 by the insertion of the inner ring 126 into the outer ring. As a result, the bore of the outer ring 128 (the smallest internal diameter perpendicular to the central axis of the outer ring) is sized to facilitate insertion of the inner ring 126 into the outer ring, and the load zone between the inner and outer rings (which corresponds to the degree of “wrap-around” of the outer ring around the inner ring) attainable between the axial ends 133, 135 is limited accordingly. The contoured axial ends 133, 135 and the limited wrap-around help prevent damage to the outer ring 128 when the outer ring flexes upon insertion of the inner ring 126 therein to assemble the bearing 122.

In a particular embodiment, the outer ring 128 of the bearing 122 has an outside diameter OD₁₂₈ of about 150 mm (about 5.9 inches (in.)), an axial width Wo₁₂₈ of about 55 mm (about 2.2 in.) and a bore of about 126 mm (about 5 in.), while the inner ring 126 has a convex bearing surface 132 that conforms to a spherical diameter Di₁₂₆ of about 134 mm (about 5.2 in.) and has an axial width Wi₁₂₆ of about 70 mm (about 2.7 in.). The inner ring 126 also has a bore defined by an interior, cylindrical shaft bearing surface 134 having a diameter of about 100 millimeters (mm) (about 4 inches (in.)). When the bearing 122 is used in a pivot joint of an A-arm frame for a haul vehicle, the bearing performs poorly when exposed to impact loading, due to the hard and brittle condition of the through-hardened steel inner and outer rings. Any surface fracturing that occurs on a ring due to sudden and high impact loads propagates through the outer ring, usually leading to a failure of the pivot joint.

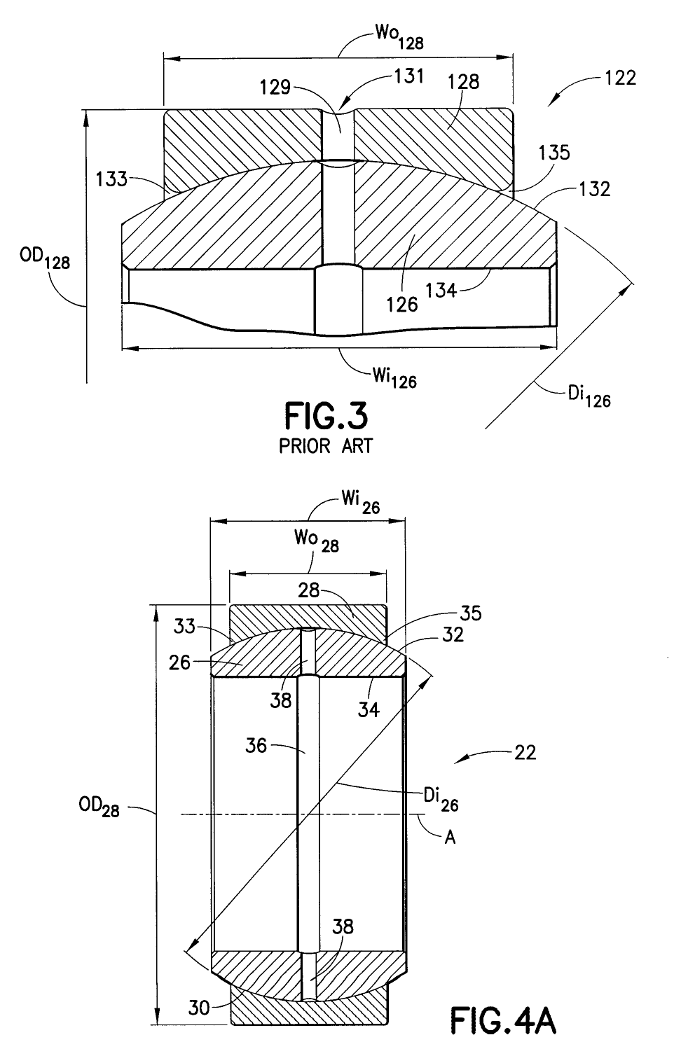

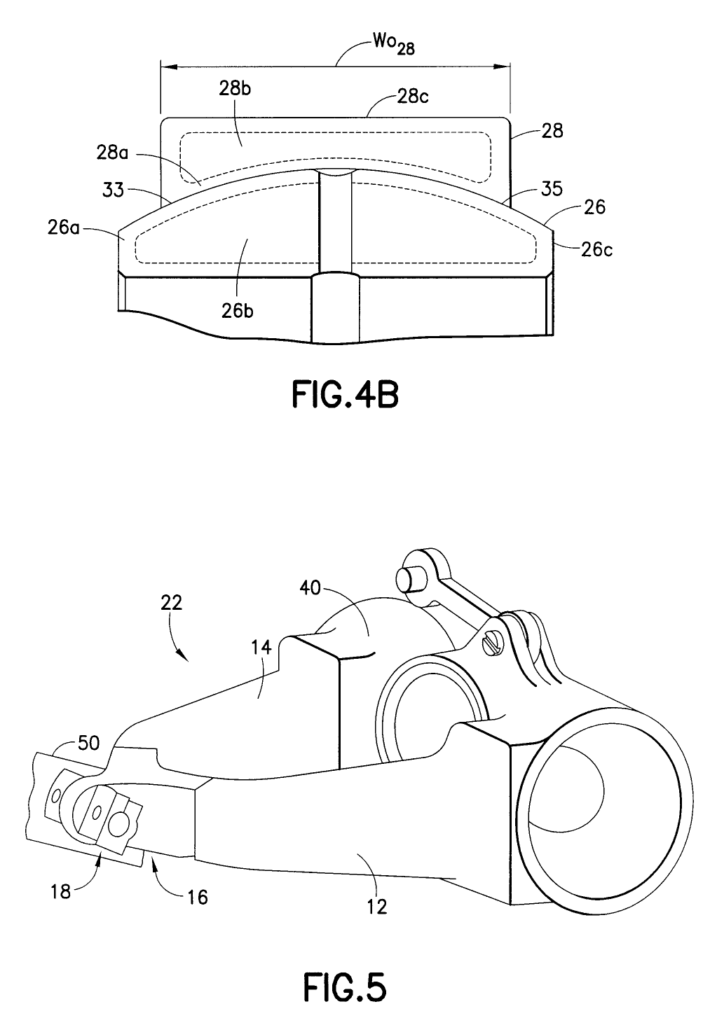

The bearing 22 according to this invention, as seen in FIGS. 4A and 4B, is a spherical plain bearing that includes an inner ring 26 disposed within an outer ring 28. The outer ring 28 has a concave bearing surface 30. The inner ring 26 has a convex bearing surface 32 and a bore defined by a shaft-bearing surface 34 that engages the linking pin 20 (FIG. 2) that may be disposed therein. The inner ring 26 is disposed within the outer ring 28 with the concave bearing surface 30 engaging the convex bearing surface 32 and defining a bearing load zone between the concave bearing surface and the convex bearing surface. The shaft-bearing surface 34 is provided with a lubrication groove 36 through which lubricant (e.g., lubricating grease) can be provided to a linkage load zone between the shaft-bearing surface 34 and the linking pin 20. The lubricant may be provided to the linkage load zone via the lubrication supply conduit 24 in the linking pin 20. The inner ring 26 also has one or more apertures 38 extending therethrough from the shaft bearing surface 34 to the convex bearing surface 32, to permit lubricant to flow from the linkage load zone to the bearing load zone. However, unlike outer ring 128 of bearing 122, the outer ring 28 does not have any lubrication aperture therethrough. Accordingly, lubricant flowing in the bearing 22 from the linkage load zone to the bearing load zone is not vented from the bearing load zone through such apertures in the outer ring 28.

The outer ring 28 has a multi-fracture configuration, e.g., a double-fracture configuration, so the outer ring can be assembled around the inner ring 26 and there is no need to flex the outer ring to dispose the inner ring therein, or to contour the axial ends of the concave bearing surface 30 of the outer ring 28 to facilitate insertion of the inner ring into the outer ring. In other embodiments, the outer ring 28 may have more than two fractures.

In one embodiment, the bearing 22 according to the present invention is a case-hardened bearing, i.e., both the inner ring 26 and the outer ring 28 are case-hardened, e.g., carburized, for improved impact resistance and fracture toughness. As shown in FIG. 4B, the inner ring 26 and the outer ring 28 have hard, wear-resistant cases 26a, 28a at their outside surfaces 26c, 28c. The inner ring 26 and the outer ring 28 also have tough ductile cores 26b, 28b at their respective interiors inside their cases 26a, 28a. For example, in one embodiment, the wear-resistant cases have a hardness of at least about Rockwell C59 while the cores have a hardness of not more than about Rockwell C49, for example, the case may have a hardness of about Rockwell C56 to about Rockwell C59 the core may have a hardness of about Rockwell C30 to about Rockwell C49. While carburizing is mentioned as a means to provide a case for the bearing 22, the invention is not limited in this regard, as various means of case-hardening are known to one of ordinary skill in the art, and any of such means may be employed to provide the described case-hardening for the bearing 22.

In a particular embodiment, the outer ring 28 has an outside diameter OD₂₈ of about 150 mm (about 5.9 in.) and a width Wo₂₈ of about 55 mm (about 2.2 in.) along axis A (an “axial width”). In addition, the inner ring 26 has a bore having a diameter of about 100 mm (about 4 in.) and an axial width Wi₂₆ of about 70 mm (about 2.7 in.). The inner ring 26 also has a convex bearing surface 32 that conforms to a spherical diameter Di₂₆ of about 134 mm (about 5.3 in.). However, in contrast to the prior art bearing 122, in the bearing 22, the inner ring 26 and the outer ring 28 each have an effective case 26a, 28a (e.g., the perpendicular distance from the hardened outside surface 26c, 28c to the farthest point at which a hardness of Rockwell C50 is measured) of about 0.5 to about 1.6 mm (about 0.02 to about 0.06 in.) below the outside surfaces 26c, 28c, optionally about 1.1 to about 1.6 mm (about 0.04 to about 0.06 in.) below the outside surfaces 26c, 28c. Accordingly, the bearing is made from a carburizing grade steel such as SAE8620H or the like. While particular bearing dimensions have been described, the present invention is not limited in this regard as other sized bearings can also be employed without departing from the broader aspects of the present invention.

It is believed that the hardened cases 26a, 28a provide extended bearing life and the tough ductile cores 26b, 28b resist the propagation of surface cracks through the inner ring 26 and the outer ring 28, further improving the longevity of the pivot joint 18 relative to prior art pivot joints. In addition, the double fracture construction of the outer ring 28 allows for a smaller outer ring bore and a greater wrap-around of the inner ring 26 by the outer ring than the single fracture construction of the prior art bearing 122 permits, which enables the bearing 22 to have a superior load-bearing capability relative to the prior art bearing 122.

FIG. 5 illustrates the use of the A-arm frame 10 of FIG. 1 on the housing 40 for the rear drive axle (not shown) of a haul vehicle (not shown). The pivot joint 18 joins the A-arm frame 10 and the housing 40 to the vehicle frame 50, as known in the art.

The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. An A-arm frame for joining an axle housing to a vehicle frame, the A-arm frame comprising two arms that converge at an apex, each of the arms having a mounting end opposite from the apex for mounting to the axle housing, the A-arm frame further having a pivot joint at the apex for connecting the A-arm frame to the vehicle frame, the pivot joint comprising a spherical plain bearing that comprises an inner ring and an outer ring; wherein the spherical plain bearing is a case-hardened bearing.

2. The A-arm frame of claim 1, wherein the inner ring and the outer ring that each have a surface hardness of at least about Rockwell C56 and a core hardness of not more than about Rockwell C49.

3. The A-arm frame of claim 2, having an effective case of about 0.5 millimeters to about 1.6 millimeters from the surfaces of the inner ring and the outer ring.

4. The A-arm frame of claim 1, wherein the inner ring and the outer ring that each have a surface hardness of about Rockwell C56 to about Rockwell C59 and a core hardness of about Rockwell C30 to about Rockwell C49.

5. The A-arm frame of claim 4, having an effective case of about 0.5 millimeters to about 1.6 millimeters from the surfaces of the inner ring and the outer ring.

6. The A-arm frame of claim 1, wherein the inner ring has a convex bearing surface that conforms to a spherical diameter of about 134 mm and a shaft bearing surface having a diameter of about 100 mm, and the outer ring has an outside diameter of about 150 mm; and
wherein the inner ring and the outer ring that each have a surface hardness of at least about Rockwell C56 and an effective case of about 0.5 millimeters to about 1.6 millimeters from the surfaces of the inner ring and the outer ring.

7. The A-arm frame of claim 6, wherein the inner ring and the outer ring that each have a core hardness of not more than about Rockwell C49.

8. The A-arm frame of claim 1, wherein the outer ring has no lubrication aperture therethrough.

9. The A-arm frame of claim 1, wherein the outer ring has a multi-fracture configuration.

10. The A-arm frame of claim 1, wherein the outer ring has a double fracture configuration.

11. The A-arm frame of claim 1, wherein the pivot joint comprises a linking pin in the inner ring, the linking pin having a lubrication supply conduit.

12. The A-arm frame of claim 11, wherein the inner ring includes a lubrication groove and the lubrication supply conduit permits a lubricant to pass from the linking pin to a linkage load zone between the linking pin and the inner ring.

13. The A-arm frame of claim 12, wherein the inner ring includes an aperture extending radially therethrough, the aperture permitting lubricant to pass from the linkage load zone to a bearing load zone between the inner ring and the outer ring.

14. In a vehicle comprising a vehicle frame, an axle having an axle housing and an A-arm frame joining the axle housing to the vehicle frame, the A-arm frame comprising two arms that converge at an apex, each of the arms having a mounting end opposite from the apex for mounting to the housing for an axle of the vehicle, the A-arm frame further having a pivot joint at the apex for connecting the A-arm frame to the vehicle frame, the pivot joint comprising a spherical plain bearing, and the spherical plain bearing comprising an inner ring and an outer ring; the improvement comprising that the spherical plain bearing is a case-hardened bearing.

15. The vehicle of claim 14, wherein the inner ring and the outer ring that each have a surface hardness of at least about Rockwell C56 and a core hardness of not more than about Rockwell C49.

16. The vehicle of claim 15, having an effective case of about 0.5 millimeters to about 1.6 millimeters from the surfaces of the inner ring and the outer ring

17. The vehicle of claim 14, wherein the inner ring and the outer ring that each have a surface hardness of about Rockwell C56 to about Rockwell C59 and a core hardness of about Rockwell C30 to about Rockwell C49.

18. The vehicle of claim 17, having an effective case of about 0.5 millimeters to about 1.6 millimeters from the surfaces of the inner ring and the outer ring

19. The vehicle of claim 14, wherein the inner ring has a convex bearing surface that conforms to a spherical diameter of about 134 mm and a shaft bearing surface having a diameter of about 100 mm, and the outer ring has an outside diameter of about 150 mm; and
wherein the inner ring and the outer ring that each have a surface hardness of at least about Rockwell C56 and an effective case of about 1.1 millimeters to about 1.6 millimeters from the surfaces of the inner ring and the outer ring.

20. The vehicle of claim 19, wherein the inner ring and the outer ring that each have a core hardness of not more than about Rockwell C49.

21. The vehicle of claim 14, wherein the outer ring has no lubrication aperture therethrough.

22. The vehicle of claim 14, wherein the outer ring has a multi-fracture configuration.

23. The vehicle of claim 14, wherein the outer ring has a double fracture configuration.

24. The vehicle of claim 14, wherein the pivot joint comprises a linking pin in the inner ring, the linking pin having a lubrication supply conduit.

25. The vehicle of claim 24, wherein the inner ring includes a lubrication groove and the lubrication supply conduit permits a lubricant to pass from the linking pin to a linkage load zone between the linking pin and the inner ring.

26. The vehicle of claim 14, wherein the inner ring includes an aperture extending radially therethrough, the aperture permitting lubricant to pass from the linkage load zone to a bearing load zone between the inner ring and the outer ring.
